(19) United States
(12) Patent Application Publication
(10) Pub. No.: US 2016/0135923 A1
(43) Pub. Date: May 19, 2016

(54) METHOD FOR PREPARING PRIMARY CROWN BY USING LITHIUM DISILICATE, AND PRIMARY CROWN USING SAID PREPARATION METHOD

(71) Applicant: EDEN CO., LTD., Seoul (KR)

(72) Inventors: Jung Hun AHN, Seoul (KR); Kyong Hee HONG, Seoul (KR); Sung Jin PARK, Gyeonggi-do (KR); Jun Duck SEO, Seoul (KR); Joon Chul SUNG, Gyeonggi-do (KR)

(21) Appl. No.: 14/904,415

(22) PCT Filed: Feb. 18, 2014
(86) PCT No.: PCT/KR2014/001299

§ 371 Date: Jan. 11, 2016

(30) Foreign Application Priority Data
Jul. 24, 2013 (KR) 10-2013-0087537

(51) Int. Cl. A61C 5/10

(52) U.S. Cl. CPC A61C 5/10

(57) ABSTRACT

A method for preparing a primary crown by using lithium disilicate used for restoring the primary crown of children, and a primary crown using the preparation method comprises the steps of: three-dimensionally modeling the shape of a primary crown by using a computer program; processing a wax model by using a milling machine; drawing out the wax model; embedding the wax model together with an embedding material into an embedding material frame; drying the embedding material; evaporating a wax constituting the wax model by heating the embedding material;

inserting lithium disilicate into the internal space of the embedding material and melting the same; cooling lithium disilicate; drawing out a primary crown model comprising lithium disilicate by cutting the embedding material; and polishing the primary crown model.

### BACKGROUND

The present invention relates to a method for preparing a molding primary crown by using a lithium disilicate which is provided to restore a child's prosthetic primary crown.

A child's prosthetic primary crown recovery in general is a surgical procedure to recover a tooth decay (decayed tooth) or a tooth crown of a deciduous tooth which is severely damaged by an external injury. The primary crown used for this is made of a metal, a resin and zirconia. The primary crown made of such materials does not satisfy a required strength and an aesthetic impression, and discoloration and fracture occur due to decreased color stability and strength. It may provide a bad-looking aesthetic to a front tooth array of an upper jaw which is an important portion in terms of aesthetic. The primary crown made of a resin may provide a good transparency, but it has a weak strength, and the primary crown made of zirconia may provide a strong strength, but it has a weak point in terms of aesthetic. The primary crown made of a nickel chromium is metallic, so it is very bad in terms of aesthetic.

### SUMMARY OF THE INVENTION

Accordingly, the present invention is made in an effort to resolve the above problems. It is an object of the present invention to provide a method for preparing a primary crown by using a disilicate and a primary crown using the method wherein a biologically friendly material having a strength and color which are similar with a natural tooth is used, and faster treatment time can be provided.

To achieve the above objects, there is provided a method for preparing a primary crown using lithium disilicate, which may include, but is not limited to, modeling the shape of a primary crown in 3D using a computer program; processing a wax model using a milling machine after the step for modeling in 3D the shape of the primary crown; withdrawing a wax model after the step for processing a wax model using the milling machine; embedding the wax model together with the embedding material after the step for withdrawing the wax model; drying the embedding material after the step for embedding the wax model together with the embedding material in an embedding material frame; vaporizing the wax of the wax model by heating the embedding material after the step for drying the embedding material; inserting lithium disilicate in the inner space of the embedding material and melting the same after the step or vaporizing the wax; cooling the lithium disilicate after the step for inserting the lithium disilicate in the inner space of the embedding material and melting the same; withdrawing a primary crown model made of the lithium disilicate by cutting the embedding material after the step for cooling the lithium disilicate; and polishing the primary crown model after the step for withdrawing the primary crown model.

In the step for embedding the embedding material and the wax model in the embedding material frame, the wax models are disposed at the front end of a pillar unit of a spool, and the spool and the wax model are inserted in the embedding material frame, and the embedding material is inserted in the embedding material frame.

In the step for vaporizing the wax, the wax is vaporized by heating the embedding material in a heating furnace at 850˜900° C. for 40˜55 minutes.

In the step for inserting the lithium disilicate in the inner space of the embedding material and melting the same, the lithium disilicate is melted in such a way that the embedding material is heated at 700˜920° C. and is stuck in the heating furnace for 15˜30 minutes, and the lithium disilicate is pressed at 900˜930° C. for 5˜20 minutes.

To achieve the above objects, there is provided a primary crown prepared by a method for preparing a primary crown using lithium disilicate, which includes, but is not limited to, modeling the shape of a primary crown in 3D using a computer program; processing a wax model using a milling machine after the step for modeling in 3D the shape of the primary crown; withdrawing a wax model after the step for processing a wax model using the milling machine; embedding the wax model together with the embedding material after the step for withdrawing the wax model; drying the embedding material by removing the embedding material frame after the step for embedding the wax model together with the embedding material in an embedding material frame; vaporizing the wax of the wax model by heating the embedding material after the step for drying the embedding material; inserting lithium disilicate in the inner space of the embedding material and melting the same after the step or vaporizing the wax; cooling the lithium disilicate after the step for inserting the lithium disilicate in the inner space of the embedding material and melting the same; withdrawing a primary crown model made of the lithium disilicate by cutting the embedding material after the step for cooling the lithium disilicate; and polishing the primary crown model after the step for withdrawing the primary crown model.

In the present invention, it is possible to prepare a primary crown using a lithium disilicate, thus obtaining a strength and color which are similar with a natural tooth. The surgical procedure may be available in such a way to minimally adjust a primary crown model, so the present invention can be used for children who want faster treatment. For this reason, the present invention may have strong product competitiveness.

### BRIEF DESCRIPTION OF DRAWINGS

FIG. 1 is a process flow chart for explaining a method for preparing a primary crown using a lithium disilicate according to an exemplary embodiment of the present invention.

FIG. 2 is a view illustrating a state where a spool is engaged to a wax model according to an exemplary embodiment of the present invention.

FIG. 3 is a view illustrating a procedure where a spool and a model are inserted in an embedding material frame, and an embedding material is inserted in the embedding material frame according to an exemplary embodiment of the present invention.

FIG. 4 is a view illustrating a state where a lithium disilicate is inserted in an embedding material, and a lithium disilicate is melted according to an exemplary embodiment of the present invention.

FIG. 5 is a view illustrating a procedure where the melted lithium disilicate is pressed according to an exemplary embodiment of the present invention.

### DETAILED DESCRIPTION OF THE INVENTION

The preferred exemplary embodiment of the present invention will be described with reference to the accompanying drawings to the extent that a person having ordinary skill in the art can easily carry out the present invention. It is obvious that the present invention can be implemented in various forms, not limiting to the disposed embodiments. For the same of clarified descriptions, the portions which are not related with the descriptions will be omitted, and the same or similar components throughout the specification will be assigned the same reference numbers.

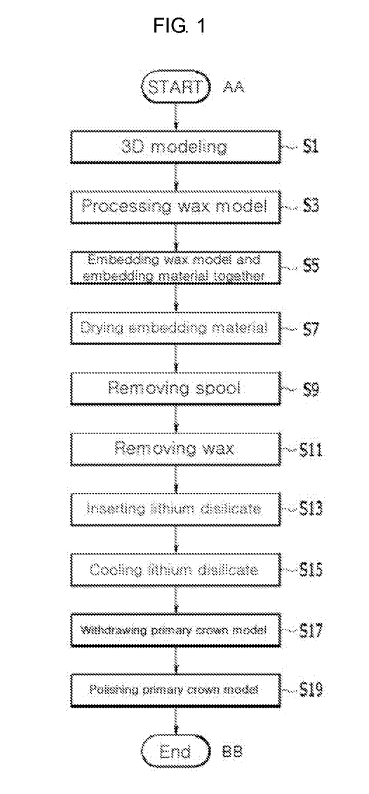

FIG. 1 shows a flow chart for describing the embodiments of the present invention and shows a method for preparing a primary crown using a lithium disilicate.

First, a worker designs a model of a primary crown using a 3D computer program (S1). It is preferred that the primary crown is modeled in a type where a dental clinic wants to adjust a type number and size of a tooth for each user.

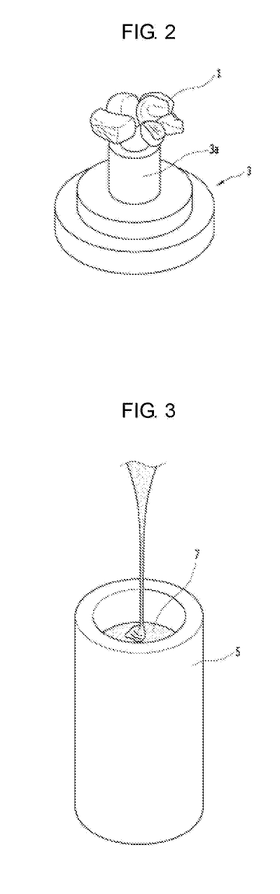

After the worker has modeled (S1) the type of a primary crown using the 3D computer program, the modeled primary crown is milled in a 1:1 processing way for each size using a precision milling machine (not illustrated), and a wax model (refer to FIGS. 1 and 2) is processed (S3).

In case where the multiple processed wax models 2 are stuck to each other, each wax model is separated using a cutter. Thereafter, after the wax model 1 has been processed (S3) using the milling machine, the worker disposes the wax model 1 at the front end of a pillar unit 3a of the spool 3 (illustrated in FIG. 2).

As illustrated in FIG. 3, the worker inserts the wax model 1 and the spool 3 together in the embedding frame 5 and inserts the embedding material 7 in the embedding material frame 5. To this end, the spool 3 and the wax model 1 are embedded by the embedding material 7. The material of the embedding material 7 may be a material, for example, gypsum.

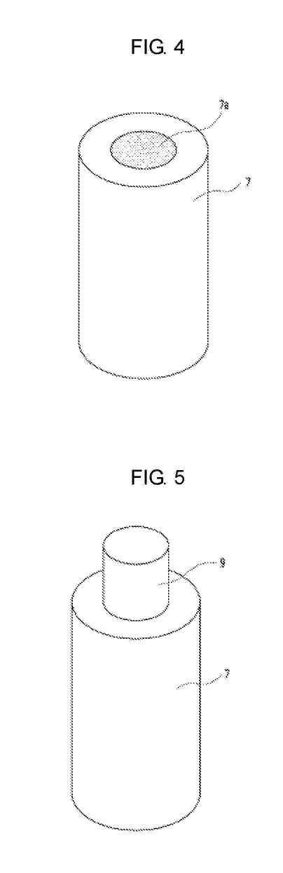

After the wax model 1 and the spool 3 have been embedded using the embedding material 7, the embedding material 7 is dried (S7). Thereafter, the spool 3 is removed from the embedding material 7. The embedding material 7 has a cylindrical shape. One side of the embedding material 7 from which the spool 3 has been removed, will have a hole 7a (illustrated in FIG. 4) into which lithium disilicate can be inserted.

After the embedding material 7 has been dried, the embedding material is inputted into a heating furnace, and the wax of the wax model 1 is heated. The wax will vaporize via the hole 7a formed at the cylindrical embedding material 7, thus removing the wax (S11).

At this time, it is preferred that the embedding material 7 is heated for 40˜45 minutes at a temperature of 850˜900° C. in the heating furnace (not illustrated).

As illustrated in FIG. 4, the worker inputs lithium disilicate into the hole 7a formed at the embedding material 7 (S13). At this time, the lithium disilicate is melted in such a way that the embedding material 7 is heated at 700˜900° C. and is stuck in the heating furnace for 15˜30 minutes. The lithium disilicate is pressed at 900˜930° C. for 5˜20 minutes (refer to FIG. 5). As illustrated in FIG. 5, a plunger 9 is inserted in the hole 7a of the embedding material 7 and the plunger 9 is pressurized by the pressing device. The lithium disilicate is compressed into the space (where the wax model was present) formed inside the embedding material 7, thus preparing a configuration shaped same as the wax mode.

The lithium disilicate is cooled (S15). The worker cuts the embedding material 7 and removes the embedding material 7, thus withdrawing (S17) a primary crown model formed of lithium disilicate. The work for removing the embedding material 7 may be carried out using a motored cutter and a sand blast method.

The primary crown model formed of lithium disilicate may be polished through a polishing work. Finally, it is possible to prepare the primary crown model made of lithium disilicate shaped same as the wax model 1.

The primary crown prepared according to the present invention may be used by a child patient, so aesthetic and strength can be enhanced, and it is possible to express colors similar with natural colors while obtaining a good wearing comfort even though the patient visits only one time the dental clinic.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A method for preparing a primary crown using lithium disilicate, comprising:
modeling the shape of a primary crown in 3D using a computer program;
processing a wax model using a milling machine after the step for modeling in 3D the shape of the primary crown;
withdrawing a wax model after the step for processing a wax model using the milling machine;
embedding the wax model together with the embedding material after the step for withdrawing the wax model;
drying the embedding material after the step for embedding the wax model together with the embedding material in an embedding material frame;
vaporizing the wax of the wax model by heating the embedding material after the step for drying the embedding material;
inserting lithium disilicate in the inner space of the embedding material and melting the same after the step or vaporizing the wax;
cooling the lithium disilicate after the step for inserting the lithium disilicate in the inner space of the embedding material and melting the same;
withdrawing a primary crown model made of the lithium disilicate by cutting the embedding material after the step for cooling the lithium disilicate; and
polishing the primary crown model after the step for withdrawing the primary crown model.

2. The method of claim 1, wherein in the step for embedding the embedding material and the wax model in the embedding material frame, the wax models are disposed at the front end of a pillar unit of a spool, and the spool and the wax model are inserted in the embedding material frame, and the embedding material is inserted in the embedding material frame.

3. The method of claim 1, wherein in the step for vaporizing the wax, the wax is vaporized by heating the embedding material in a heating furnace at 850˜900° C. for 40˜55 minutes.

4. The method of claim 1, wherein in the step for inserting the lithium disilicate in the inner space of the embedding material and melting the same, the lithium disilicate is melted in such a way that the embedding material is heated at 700˜920° C. and is stuck in the heating furnace for 15˜30 minutes, and the lithium disilicate is pressed at 900˜930° C. for 5˜20 minutes.

5. The method of claim 1, wherein the embedding material is formed of gypsum.

6. A primary crown prepared by the method recited in claim 1.
